(19) United States
(12) Patent Application Publication
(10) Pub. No.: US 2026/0233407 A1
(43) Pub. Date: Aug. 13, 2026

(54) Control method and construction robot

(71) Applicant: Hilti Aktiengesellschaft, Schaan (LI)

(72) Inventors: Andrea ALESSANDRETTI, Buchs (CH); Peer SCHMIDT, Lindau (DE); Dario BRALLA, Buchs (CH)

(21) Appl. No.: 19/459,124

(22) Filed: Jan. 26, 2026

(30) Foreign Application Priority Data
Feb. 12, 2025 (EP) 25157282.2

(51) Int. Cl. B25J 9/16; B25J 5/00; B25J 11/00

(52) U.S. Cl. CPC B25J 9/1697; B25J 5/007; B25J 11/005

(57) ABSTRACT

A method (1000) for controlling a construction robot (12), in which an at least partially transparent detection area (28) is coupled to a power tool (22) and/or to an implement (24), wherein a light spot (LP1, LP2, LP3) is projected onto a front side of the detection area (28), and wherein the power tool (22) and/or the implement (24) is or are controlled depending on the position of the light spot (LP1, LP2, LP3) within the detection area (28). A construction robot system (10) and a construction robot (12) are also provided. The present disclosure allows simple and cost-effective construction work on ceilings (D).

This claims the benefit of European Patent application EP 25157282.2, filed on Feb. 12, 2025, which is hereby incorporated by reference herein.

The present invention relates to a method for controlling a construction robot, to a construction robot and to a construction robot system.

### BACKGROUND

EP4403313A1 describes a construction robot. The construction robot has a mobile platform and a lifting device. The mobile platform has several wheels. At least one of the wheels has a height adjuster, so that an inclination of the mobile platform can be adjusted. For example, a total station can be used to position the construction robot in order to drill a hole into a ceiling at a desired working position.

Construction work generally involves very high risks of accidents. Serious accidents occur time and again, for example in building construction or civil engineering. In addition, some types of construction work may be very physically demanding on construction workers in the long term. This relates, for example, to work on high ceilings and overhead work in general.

In order to counter such dangers and also to generally protect the health of construction workers, construction robots are increasingly being used.

### SUMMARY OF THE INVENTION

Particularly when working on ceilings, it is often difficult to guide a construction machine to a working position at which construction work, for example drilling of a borehole, is to be performed.

Although these working positions can be precisely located with the aid of total stations for example, due to high costs their use is often worthwhile only on large construction sites with a correspondingly high number of construction work operations to be performed. There is also often no line of sight between a total station and a working position to be marked.

It is also difficult, in the case of ceilings, in particular at high altitude, to mark on the ceiling the working positions at which the construction work is to be performed so that a construction machine could later perform the desired construction work at the marked working position. If, for example, the marking is to be made on the ceiling with a pen, a marking machine or a construction worker has to reach the ceiling with the pen. This is often very cumbersome, especially in the case of high ceilings.

It is an object of the present invention to provide methods and devices with which construction work can be performed on ceilings in a simple and cost-effective manner.

The present invention provides a method for controlling a construction robot, in which an at least partially transparent detection area is coupled to a power tool and/or to an implement, wherein a light spot is projected onto a front side of the detection area, and wherein the power tool and/or the implement are/is controlled depending on the position of the light spot within the detection area.

It is thus possible to mark a position on the detection area by means of the light spot. The position may correspond to a working position on a ceiling, for example. Therefore, the working position can be indirectly marked by means of the light spot or a laser that generates the light spot, without a line of sight being required there. As a result, marking of working positions on ceilings, for example, can be simplified.

The robot can thus be moved to a position until the light spot hits the detection area and/or reaches a corresponding marking on the detection area.

It is also not necessary to reach the ceiling in order to make, for example, a marking with a pin there. This also simplifies marking of working positions.

The detection area may be a partially transparent detection area or a transparent detection area.

A further concept of the invention is that of making the detection area at least partially transparent. The light spot is projected onto the front side of the detection area. As a result of the at least partial transparency of the detection area, the light spot is also visible from a rear side opposite the front side. The position of the light spot within the detection area can therefore be detected without the front side having to be partially or completely concealed by a sensor or the like.

The detection area may be part of a detector, preferably an integral constituent part of the detector. In one refinement, the detection area is separate from the detector, for example camera. In this case, a detection area can be provided, for example, on the construction robot, in particular fixed to a holder provided for this purpose or to a frame provided for this purpose.

From the rear side, the profile of the light beam that generates the light spot can appear to be continued, so that an apparent point of incidence of the light beam on the ceiling can be defined as the working position. A user can thus be given the impression that they would mark the working position on the ceiling by means of the light beam by way of directing the light beam onto the detection area. A line of sight to the ceiling, in particular to the working position, is not required in this case. Overall, this provides the user with a particularly intuitive procedure for marking the working position on the ceiling.

Since, in principle, no total station or the like is required for this method, the costs for such a total station or the like can be saved, at least in part, as a result of which the method can also be carried out in a particularly cost-effective manner.

The detection area can be embodied as a diffusor. For example, the detection area can comprise frosted glass or the like. As a result, the light spot can be particularly readily identified from the front side.

The position of the light spot on the detection area can be detected by means of a camera, in particular from the rear side. This may be more cost-effective than if the detection area were equipped with a surface sensor, for example.

The detection area can preferably be arranged at a distance from the implement, in particular from a tip of the implement. The detection area can be located, for example, significantly below the implement tip. There can therefore still be a line of sight to the detection area even if the working position on the ceiling is concealed, for example by adjacent installation elements.

However, the distance between the detection area and the implement or the implement tip can result in an offset between the working position ascertained on the basis of the position of the light spot on the detection area and an actual target working position. In order to compensate for this offset, an angle of inclination of the construction robot, in particular a lifting device of the construction robot, the power tool and/or the implement, can be measured. The angle of inclination can be compensated for by adjusting the construction robot, in particular the lifting device, an arm of the construction robot and/or the power tool.

In this way, it is possible to improve the precision of ascertaining the working position on the ceiling and thus overall the precision with which construction work can be performed on ceilings. Our own investigations have shown that the position error can be reduced to less than 2 mm.

It is conceivable, in particular, for the light spot to be generated by a vertical line laser. The vertical line laser may be a single-beam laser; it may also be a multi-beam laser, for example a cross line laser.

The vertical line laser can comprise a spirit level and/or a bubble level in order to ensure its exactly vertical orientation. The spirit level can be analogue and/or digital. The vertical line laser can therefore generate a vertical light beam. The user can thus intuitively mark the working position on the ceiling, for example starting from a marking, for example a point, on a floor on which the construction robot is located.

It is conceivable, for example, for the user to initially mark the working position on the ceiling by means of the vertical line laser. The user then moves the construction robot into the vicinity until the vertical line laser no longer reaches the ceiling with its laser beam, but rather marks a light spot on the detection area of the construction robot. The construction robot can then, for its part, infer the working position to be machined from the position of the light spot on the detection area. The construction work can then be performed at the working position ascertained in this way, even if the construction robot covers the working position during the performance of the construction work and thus the light beam can no longer reach the ceiling.

Working positions on ceilings are often also initially marked on floors. By means of the vertical line laser, it is then possible to aim at the marking on the floor and then to transmit this marking vertically onto the ceiling by way of the vertical line laser extending the light beam. This also provides a very simple possible way for the user to mark working positions on the ceiling for the construction robot. This procedure is also particularly intuitive for the user. Physical stress on the user is avoided since only points on the floor have to be marked.

Overhead work and/or work at a large height, for example at a height of 5 m, for example for marking working positions on ceilings, can thus be avoided.

From safety points of view, provision may be made for the construction work to be performed only as long as an actuating element controlling the performance is actuated. The actuating element can be a button, for example. This results in an emergency-off function in the case of which the user of the construction robot merely has to release the actuating element in order to stop the construction robot.

It is conceivable for the construction robot to be manually positioned in advance such that the light spot hits the detection area. The user can therefore roughly position the construction robot in advance. Fine positioning is not required. It is sufficient for the light spot to hit the detection area. By contrast, complex hardware and software for autonomous or semi-autonomous rough positioning can be dispensed with in the case of the construction robot. For example, extensive protective devices can be dispensed with if only the user moves the construction robot. Fall protection means may also be superfluous. As a result, the production costs for the construction robot can be considerably reduced.

The scope of the invention also includes a construction robot, which can preferably be configured for use in the method described above. The construction robot has a mobile platform and a lifting device. The construction robot further has an at least partially transparent detection area, which is coupled to a power tool and/or an implement.

A light beam can be directed onto the detection area. The resulting light spot on the detection area can implicitly mark a working position, for example on a ceiling. The construction robot can ascertain the position of the light spot on the detection area. It can position its power tool and/or the implement on, for example, the ceiling in accordance with the position and perform construction work there. As a result, it is particularly easy for the user to use the construction robot. The construction robot can be of straightforward design overall, and therefore it can be produced in a cost-effective manner. Construction work can therefore be performed in a cost-effective and simple manner overall.

The detection area is coupled to the power tool and/or the implement. The detection area can therefore be moved together with the power tool and/or the implement. Therefore, for example during movement of the power tool, the position of the light spot within the detection area can be monitored by the construction robot. By means of this monitoring, the power tool and/or the implement can be guided to the working position in a simple manner. It is also possible, during the performance of construction work, to monitor whether the power tool and/or the implement are/is still located at the planned working position.

The mobile platform can have at least one wheel with a height adjuster. The construction robot can adjust an angle of inclination by means of the height adjuster. For example, it may adjust a yaw angle and/or a roll angle. Wheels that are relatively cost-effective can be used. For example, omnidirectional wheels can be dispensed with. In the case of fine positioning, maneuvering movements can be dispensed with. Wear of the wheels can be reduced. The service life of the construction robot, in particular of wearing parts, for example the wheels, can be extended.

In order to detect its angle of inclination, the construction robot can have an inclination sensor. The inclination sensor can be arranged, in particular, on the lifting device and/or in the vicinity of the power tool.

The construction robot can have a rotary arm. The rotary arm can be configured to rotate about a vertical Z-axis of the construction robot, in particular about a longitudinal direction of the lifting device of the construction robot. The rotary arm can additionally be longitudinally adjustable. The construction robot can therefore be designed in the manner of a SCARA robot with at least two degrees of freedom. The construction robot can preferably have at least the two degrees of freedom of the rotary arm and further degrees of freedom due to the height adjustment of the mobile platform.

The lifting device can also provide an additional degree of freedom, in particular in a vertical or at least substantially vertical direction. It is further conceivable for the construction robot to be configured to detect a light spot incident on a front side of the detection area from a rear side opposite the front side. This allows shade-free detection of the position of the light spot on the detection area by the construction robot.

The scope of the invention further includes a construction robot system comprising a construction robot of the kind described above and a vertical line laser. The vertical line laser can be arranged on a stand, for example a tripod. Such a construction robot system can be produced in a cost-effective manner due to its simple structure. It is intuitive and thus easy for a user to operate. The user can therefore aim at a point on a floor of a construction site by means of the vertical line laser, for example, and manually move the construction robot into the vicinity of the vertical line laser such that the vertical line laser hits the detection area of the construction robot. Subsequently, the user can start the construction robot by means of the actuating element, as a result of which the construction robot can move its implement vertically above the point on the floor to an opposite ceiling and perform construction work there.

Further features and advantages of the invention will emerge from the following detailed description of an exemplary embodiment of the invention, with reference to the figures of the drawing, which show details essential to the invention, and from the claims.

The individual features can be implemented individually in their own right or collectively in any combinations in variants of the invention. Exemplary embodiments of the invention are illustrated in the schematic drawing and will be explained in more detail in the following description.

### BRIEF DESCRIPTION OF THE DRAWINGS

In the drawings:

FIG. 1 shows a construction robot system comprising a construction robot and a vertical line laser,

FIG. 2 is a schematic illustration of a position error, and

FIG. 3 shows a method for controlling a construction robot.

To facilitate understanding of the invention, the same reference signs are used for corresponding elements in the following description of the figures.

### DETAILED DESCRIPTION

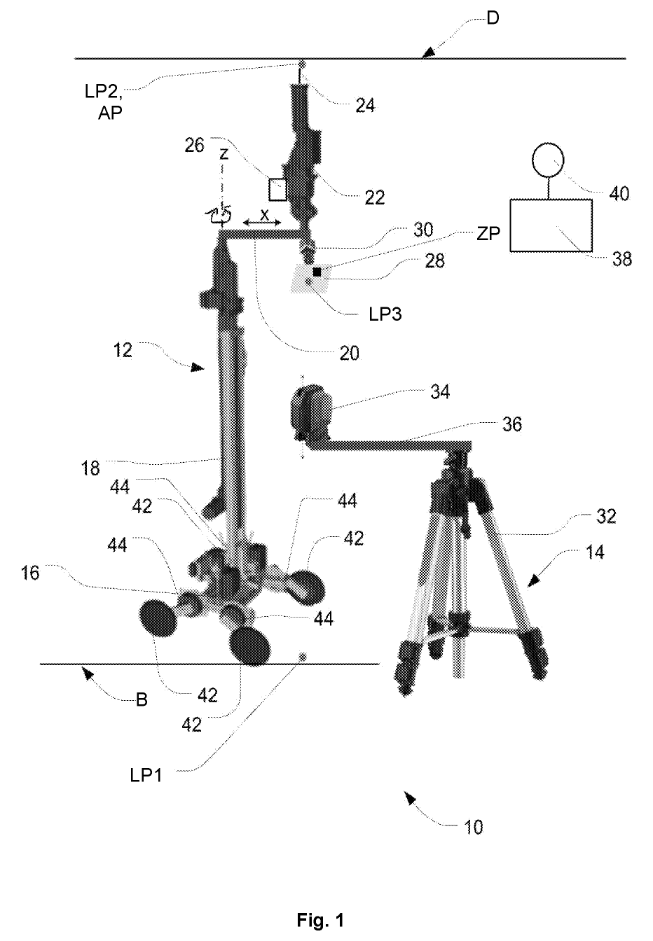

FIG. 1 shows a construction robot system 10 comprising a construction robot 12 and a laser device 14.

By way of example, it is assumed that a working position AP is on a ceiling D with the construction robot system 10 vertically above a point LP1 on a floor B. The intention is for a borehole to be drilled into the ceiling D at this working position AP.

The construction robot 12 has a mobile platform 16, on which a lifting device 18 is arranged. At its free end, the lifting device 18 has a rotary arm 20, on which a power tool 22 with an implement 24 is mounted.

The lifting device 18 can be longitudinally extended, so that the height of the power tool 22 together with its implement 24 can be adjusted.

The rotary arm 20 is mounted rotatably by motor about an axis of rotation Z around the lifting device 18. Furthermore, the rotary arm 20 has a linear drive in order to adjust its length along an axis X and thus the radial distance of the implement 24 from the axis of rotation Z.

In this exemplary embodiment, the power tool 22 is designed as a hammer drill. The implement 24 is a masonry drill suitable for the ceiling D.

Angles of inclination with respect to the vertical, in particular the direction of gravitational force, can be detected by an inclination sensor 26.

The rotary arm 20 has a detection area 28 on the bottom side, in particular on a side opposite the power tool 22. In the present exemplary embodiment, the detection area 28 is formed from frosted glass and as a result is partially transparent, in particular translucent. A camera 30, by way of which a rear side of the detection area 28 can be recorded and analyzed, is located between the rotary arm 20 and the detection area 28.

The detection area 28 can have, for example, a size of 15 X 15 cm².

The laser device 14 comprises a stand 32 having a vertical line laser 34. The vertical line laser 34 is arranged to the side of the rest of the stand 32 by means of a stand arm 36.

The vertical line laser 34 is configured to emit light both downwards and upwards. Its downwardly directed light beam hits the floor B at the point LP1.

Without the construction robot 12, its upwardly directed light beam would directly hit the ceiling D at the working position AP. This is shown symbolically in FIG. 1, in which the working position AP is additionally marked by reference sign LP2.

In the situation shown in FIG. 1 however, the construction robot 12 is located in the emission region of the laser device 14. The construction robot 12 therefore shades the upwardly directed light beam, so that it cannot hit the working position AP. However, the upwardly directed light beam hits the detection area 28, on which it generates a light spot LP3 both on a front side of the detection area 28 and on the rear side.

The construction robot 12 is configured to move the detection area 28 until the light spot LP3 detected from the rear side by the camera 30 comes to lie on a target point ZP.

Since the power tool 22 together with its implement 24 is coupled to the detection area 28, the former correspondingly moves with the latter when it moves.

The detection area 28 can be moved by means of the rotatable arm 20 adjustable along the axis X and by rotation about the axis of rotation Z.

In addition, wheels 42 of the mobile platform 16 have height adjusters 44.

The height adjusters 44 can be used to incline the mobile platform 16, and thus the lifting device 18 with the components mounted on it, in different directions. In particular, the angle of inclination can be adjusted by motor. This results in additional possible ways of positioning the detection area 28 and thus also the power tool 22 together with its implement 24.

Owing to these additional possibilities, firstly unevennesses of the floor B can be compensated for. Furthermore, the implement 24 can be moved at least to a limited extent without moving the entire mobile platform 16. As a result, the mechanics of the rotary arm 20, in particular motor-assisted mounting of the rotary arm about the axis of rotation Z, can also be cost-effective.

In particular, adjustment of the rotary arm 20 about the axis of rotation Z by motor requires only a low level of precision.

As soon as the light spot LP3 has reached the target point ZP, the power tool 22 can be moved vertically or at least substantially vertically towards the ceiling D in order to perform the intended construction work there at the working position AP, in this example drilling of a borehole.

In order to start or stop the process, a remote controller 38 is provided for remote control of the construction robot 12. The remote controller 38 has an actuating element 40. The actuating element 40 can be designed as a monostable button. Here, the construction robot 12 is configured to move only when the actuating element 40 is actuated.

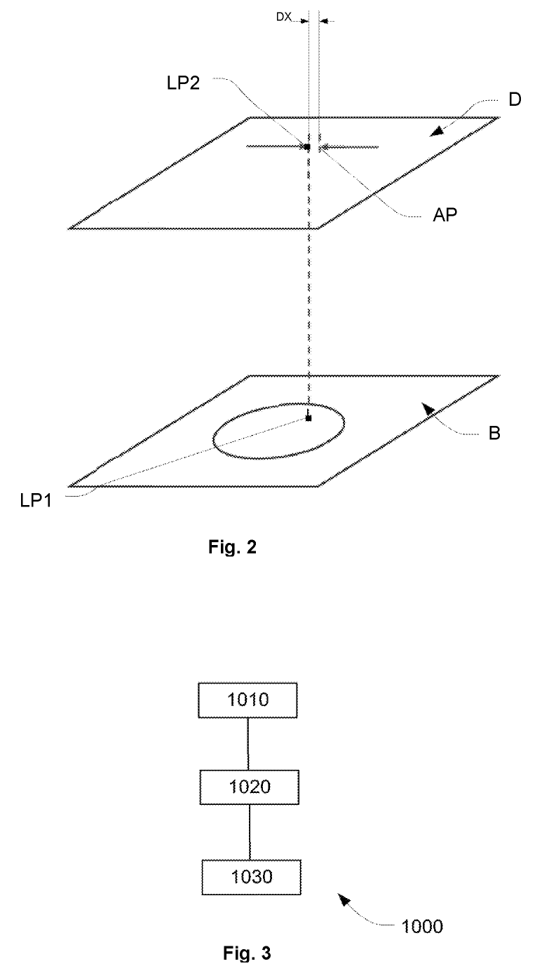

FIG. 2 shows, in a schematic illustration, that the working position AP ascertained in this way can deviate from the original position of the light spot LP2, that is to say in the absence of the construction robot 12, by a position error DX.

This position error DX can arise in particular owing to an oblique position of the power tool 22 with respect to the vertical in conjunction with the distance between the detection area 28 and the implement 24 that can lie in the range of from 30 to 60 cm, for example.

Therefore, the construction robot 12 is configured to detect such an oblique position by means of its inclination sensor 26. For compensation purposes, the construction robot 12 can determine a target position ZP modified in accordance with the inclination and can then orient itself in such a way that the light spot LP3 comes to lie on this modified target position ZP. As an alternative or in addition, the construction robot 12 can also be configured to be correspondingly inclined, for example by means of the height adjusters 44, until the position error DX is compensated for.

Finally, FIG. 3 shows a method 1000 for controlling a construction robot.

In order to facilitate understanding, the method 1000 will be explained in more detail using the elements introduced above and the reference signs of these elements.

Furthermore, it is assumed by way of example that a marking is present on the floor B, the intention being for a borehole to be drilled in the opposite ceiling D above the marking in the vertical direction.

In a step 1010, the laser device 14 with the vertical line laser 34 is positioned such that the downwardly directed light beam of the vertical line laser 34 hits the marking on the ground B by way of its light spot LP1.

In a step 1020, the construction robot 12 is moved into the vicinity of the laser device 14 by a user. It is positioned such that the upwardly directed light beam of the vertical line laser 34 hits the detection area 28 of the construction robot 12.

In a step 1030, the user actuates the actuating element 40 in order to put the construction robot 12 into operation.

The construction robot 12 uses its camera 30 to ascertain the position of the light spot LP3 within the detection area 28. In addition, it measures angles of inclination with respect to the vertical by means of the inclination sensor 26.

If a deviation from the vertical is detected, the construction robot compensates this inclination, in particular of the power tool 22 and the implement 24, by means of the height adjusters 44 until the tip of the implement 24 is located vertically above the target point ZP.

By adjusting its rotary arm 20 in the radial direction, in particular along the axis X, by rotation about the axis of rotation Z and/or by adjusting the mobile platform 16, the construction robot 12 maneuvers the target point ZP to the light spot LP3. The power tool 22 moved along as a result and its implement 24 are thus controlled depending on the position of the light spot LP3 within the detection area 28.

By extending the lifting device 18, the construction robot 12 moves the implement 24 closer to the ceiling D and, when contact is made with the ceiling D, drills the desired borehole into the ceiling by means of the power tool 22.

While the lifting device 18 is being extended and during the rest of the drilling operation, the construction robot 12 may continuously monitor and compensate for its angle of inclination with respect to the vertical.

After completion of the construction work, that is to say drilling of the borehole, the construction robot 12 moves the implement 24 out of the drilled borehole and terminates its activity.

If the user were to release the actuating element 40 while the construction work is being performed, the construction robot 12 would interrupt its activity.

By way of example, in the exemplary embodiments described above, the construction robot 12 is designed as a drilling robot. In alternative embodiments, the construction robot 12 may also be designed for performing other construction tasks, for example for separating, grinding and/or measuring. For this purpose, the power tool 22 together with its implement 24 can be designed correspondingly in each case, for example as a saw, grinder and/or laser rangefinder.

### LIST OF REFERENCE SIGNS

10 Construction robot system

12 Construction robot

14 Laser device

16 Mobile platform

18 Lifting device

20 Rotary arm

22 Power tool

24 Implement

26 Inclination sensor

28 Detection area

30 Camera

32 Stand

34 Vertical line laser

36 Stand arm

38 Remote controller

40 Actuating element

42 Wheel

44 Height adjuster

AP Working position

B Floor

D Ceiling

DX Position error

LP1 Light spot

LP2 Light spot

LP3 Light spot

X Axis

Z Axis of rotation

ZP Target point

1000 Method

1010 Step

1020 Step

1030 Step

What is claimed is:

1. A method for controlling a construction robot, an at least partially transparent detection area of the construction robot being coupled to a power tool or to an implement, the method comprising:
projecting a light spot onto a front side of the detection area; and
controlling the power tool or the implement depending on a position of the light spot within the detection area.

2. The method as recited in claim 1 wherein the position of the light spot on the detection area is detected via a camera.

3. The method as recited in claim 2 wherein the camera detects the position from a rear side opposite the front side.

4. The method as recited in claim 2 wherein the detection area is arranged separately from the camera.

5. The method as recited in claim 1 further comprising measuring an angle of inclination of the construction robot, the power tool or the implement.

6. The method as recited in claim 1 further comprising measuring an angle of inclination of a lifting device of the construction robot.

7. The method as recited in claim 1 further comprising generating the light spot by a vertical line laser.

8. The method as recited in claim 1 wherein construction work is performed only as long as an actuating element controlling performance is actuated.

9. The method as recited in claim 1 further comprising manually positioning the construction robot such that the light spot hits the detection area.

10. A construction robot, the contruction robot comprising:
a mobile platform;
a lift; and
a partially transparent detection area coupled to a power tool or an implement.

11. The construction robot as recited in claim 10 wherein the mobile platform has at least one wheel with a height adjuster.

12. The construction robot as recited in claim 11 wherein the lift has an inclination sensor.

13. The construction robot as recited in claim 10 further comprising an inclination sensor.

14. The construction robot as recited in claim 10 further comprising a rotary arm.

15. The construction robot as recited in claim 10 wherein the construction robot is configured to detect a light spot incident on a front side of the detection area from a rear side opposite the front side.

16. The construction robot as recited in claim 10 wherein the configured to control the power tool or the implement depending on a position of the light spot within the detection area.

17. A construction robot system comprising:
the construction robot as recited in claim 10; and
a vertical line laser arranged on a stand.

18. The construction robot system as recited in claim 17 wherein the stand is a tripod.
